(19) United States
(12) Patent Application Publication
(10) Pub. No.: US 2005/0043455 A1
(43) Pub. Date: Feb. 24, 2005

(54) Modified polyolefin waxes

(75) Inventor: Gerd Hohner, (US)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/922,303

(22) Filed: Aug. 19, 2004

(30) Foreign Application Priority Data
Aug. 21, 2003 (DE) 103 38 344.1

(51) Int. Cl. C08K 5/24; C08K 5/01; C08K 3/40; C08L 91/08

(52) U.S. Cl. 524/261; 524/494; 524/487; 525/333.7

(57) ABSTRACT

The invention relates to partially crystalline polyolefin homopolymer or copolymer waxes modified free-radically with a silane compound and having a viscosity as measured at 170° of between 10 and 50 000 mPa.s and a heat of fusion >10 J/g, wherein the silane compound used for modification includes at least one olefinic double bond and at least one alkoxy radical attached directly to silicon and wherein the polyolefin waxes used for modification have been prepared using a metallocene catalyst. The invention also relates to a process for preparing these polyolefin homopolymer or copolymer waxes and to their use.

The present invention is described in the German priority application DE 103 38 344.1, filed Aug. 21, 2003, which is hereby incorporated by reference as is fully disclosed herein.

The present invention relates to partially crystalline polyolefin homopolymer or copolymer waxes modified free-radically with a silane compound and having a viscosity as measured at 170° C. of between 10 and 50 000 mPa.s and a heat of fusion of >10 J/g, their preparation and their use.

The modification of polyolefin polymers by free-radical grafting with unsaturated alkoxysilanes is known. As an example Ullmann's Encyclopedia of Industrial Chemistry, 5th ed. 1993, Vol. A 24, pp. 47-48 describes the reaction of polyethylene polymer with trimethoxyvinylsilane. The functionalized material obtained in the course of this reaction can be shaped appropriately and then crosslinked by hydrolysis and condensation reactions in order to obtain optimization of the mechanical properties (Monosil or Sioplas process).

EP-A-0 944 670 describes mixtures which in addition to unmodified polyolefin include elastomeric, silane-grafted ethylene-alpha-olefin copolymers having melt indices of between 0.1 and 500 g/10 min.

EP-A-0 827 994 describes the use of silane-grafted, substantially amorphous poly-α-olefins as hot-melt adhesives. Poly-α-olefins used include atactic polypropylene or poly-1 -butene or copolymers or terpolymers of C₄-C₁₀ α-olefines with ethylene or propylene, the latter either being completely amorphous or having a low degree of crystallinity at best. Olefinically unsaturated alkoxysilanes are used for grafting. The reactivity of the alkoxysilane groups produces first an improvement in the cohesion of the hot-melt adhesives through crosslinking and secondly an improvement in the adhesion, through chemical attachment to the substrate surfaces to be bonded, where those surfaces are themselves reactive. The modification products described therein, however, have performance disadvantages, particular mention being deserved by the inadequate storage stability and color stability.

Hot-melts are solvent-free adhesives which are applied in the hot, liquid-melt state to the substrates to be bonded and which develop their adhesive effect after they solidify. Because of their multifarious advantages they are increasingly being used in industries including those of packaging, furniture, textiles and footwear as an economic and environment-friendly alternative to conventional, solvent-based adhesives. Constituents of common hot-melt formulas are polar or apolar polymers (generally ethylene-vinyl acetate copolymers), resins and waxes.

The polar or apolar polymers serve as scaffold material: they ensure the cohesion of the adhesive and at the same time contribute to the adhesion to the substrate. The resin addition improves the adhesion and may exert a compatibilizing effect on the various components of the adhesive. Waxes are used for modification, but where appropriate may also serve as scaffold material. They regulate important physical properties of the adhesives, such as hardness, melt viscosity and softening point, and in their effect on open time, setting time, adhesion, cohesion, etc. they decisively influence the performance characteristics.

Waxes used to date have included macrocrystalline and microcrystalline paraffin waxes, Fischer-Tropsch waxes and polyolefin waxes.

It has now surprisingly been found that polyolefin waxes modified with silane compounds and prepared using metallocene catalysts are outstandingly suitable for use in hot-melt adhesives. The modified waxes can be used per se or in blends with suitable further components customary for hot-melt adhesive compositions, such as resins, polymers, nonreactive polyefin waxes, etc. Hot-melt adhesives which include such silane-modified waxes possess not only the particular adhesion and cohesion properties as a result of the chemical reactivity but also, in particular, advantages in respect of storage stability and color stability and also in the setting time.

The silane-modified metallocene waxes of the invention are additionally suitable as adhesion promoters for improving fiber/matrix adhesion in the compounding of thermoplastics, examples being polyamides, polyesters or polyolefins such as polyethylene or polypropylene, with glass fibers, with natural fibers such as flax or hemp or with wood flour. In addition the waxes of the invention are suitable for coating other functional surfaces, such as glass, metal, cellulose-based surfaces such as paper, cardboard, etc.

The present invention accordingly provides partially crystalline polyolefin homopolymer or copolymer waxes modified free-radically with a silane compound and having a viscosity as measured at 170° C. of between 10 and 50 000 mPa.s and a heat of fusion >10 J/g, wherein the silane compound used for modification includes at least one olefinic double bond and at least one alkoxy radical attached directly to silicon and wherein the polyolefin waxes used for modification have been prepared using a metallocene catalyst.

The partially crystalline polyolefin homopolymer or copolymer waxes modified free-radically with a silane compound preferably have a melt viscosity as measured at 170° C. of between 50 and 10 000 mPa.s, a dropping point or ring & ball softening point of between 75 and 170° C., preferably between 85 and 150° C., and a heat of fusion of >20 J/g, preferably >30 J/g.

These polyolefin homopolymer or copolymer waxes more preferably have a heat of fusion of >40 J/g, very preferably >50 J/g.

Since the heat of fusion is a measure of the crystallinity, the waxes in question are therefore waxes having a notable or high degree of crystallinity.

The modified polyolefin homopolymer wax is preferably prepared from a 1-olefin having 2 to 18 carbon atoms.

The modified polyolefin copolymer wax is preferably prepared from at least two
1-olefins each having 2 to 18 carbon atoms.

The modified polyolefin wax is more preferably prepared from 80 to 100 mol % of propylene and from 0 to 20 mol % of ethylene or from 80 to 100 mol % of propylene and from 0 to 20 mol % of a C₄-C₁₀ 1-olefin.

In respect of the modified polyolefin wax of the invention it is preferred to use for the grafting reaction at least one alkoxyvinylsilane of the general formula
CH₂═CR¹—(COO)ₓ(CₙH₂ₙ)_{y}Si(R²)_{z}(OR³)_{3-z},
where R¹ is hydrogen or CH₃ and R² and R³ are branched or unbranched alkyl radicals having 1 to 6 carbon atoms, n is 1 to 6, x and y are 0 or 1, y being 1 if x is 1, and z is 0 to 2.

In respect of the modified partially crystalline polyolefin wax it is particularly preferred to use for the grafting reaction vinyltrimethoxysilane or vinyltriethoxysilane.

The modified partially crystalline polyolefin wax preferably has a dropping point of between 75 and 170° C.

The invention also relates to a process for preparing partially crystalline polyolefin waxes modified free-radically with at least one silane compound and having a viscosity as measured at 170° C. of between 10 and 50 000 mPa.s and a heat of fusion of >10 J/g by reacting a polyolefin wax with unsaturated silane compounds, using a free-radical initiator, the polyolefin waxes used for modification having been prepared using a metallocene catalyst.

The unsaturated silane compound is preferably vinyltrimethoxysilane or vinyltriethoxysilane.

The invention also provides, finally, for the use of modified polyolefin waxes in hot-melt adhesives.

The invention likewise provides for the use of modified polyolefin waxes in polymer compounds comprising glass fibers, natural fibers or wood flour.

The invention further provides for the use of modified polyolefin waxes for adhesively bonding paper, cardboard, wood, glass, metal, polyamides, polyesters or polyolefins, including polyolefins containing partly fluorinated or perfluorinated olefins.

As already referred to above, suitable polyolefin wax base materials for the silane modification include homopolymers of ethylene or higher 1-olefins or the copolymers thereof with one another. 1-Olefins used are linear or branched olefins having 3 to 18 carbon atoms, preferably 3 to 6 carbon atoms. These olefins may contain aromatic substitution in conjugation with the olefinic double bond. Examples thereof are propene, 1-butene, 1-hexene, 1-octene or 1-octadecene and styrene. Preference is given to homopolymers of ethylene or propene or copolymers thereof with one another. The copolymers are composed of from 70 to 99.9%, preferably from 80 to 99% by weight, of one kind of olefin.

Suitable olefin homopolymer and copolymer waxes are those having a weight-average molar mass M_{w} of between 1000 and 30 000 g/mol, preferably between 2000 and 20 000 g/mol, a number-average molar mass Mₙ of between 500 and 20 000 g/mol, preferably between 1000 and 10 000 g/mol, a dropping point or ring & ball softening point of between 80 and 165° C., preferably between 90 and 160° C., and a melt viscosity as measured at 170° C. of not more then 40 000 mPa.s, preferably between 100 and 20 000 mPa.s.

The polyolefin waxes used in accordance with the invention are prepared using metallocene compounds of the formula I. 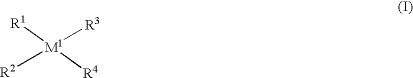
This formula also embraces compounds of the formula Ia 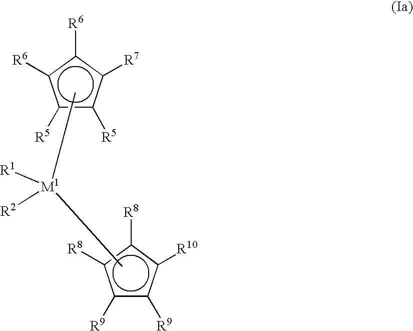
of the formula Ib 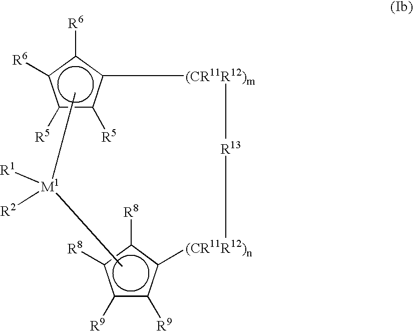
and of the formula Ic

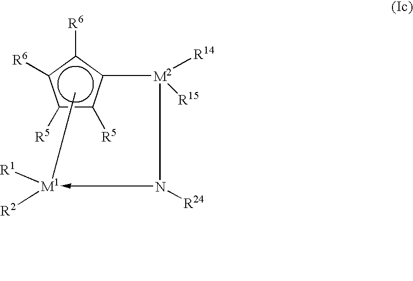

In the formulae I, Ia and Ib M¹ is a metal from group IVb, Vb or VIb of the Periodic Table, examples being titanium, zirconium, hafnium, vanadium, niobium, tantalum, chromium, molybdenum and tungsten, preferably titanium, zirconium or hafnium.

R¹ and R² are identical or different and are each a hydrogen atom, a C₁-C₁₀, preferably C₁-C₃ alkyl group, especially methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀, preferably C₇-C₁₀ arylalkyl group, a C₇-C₄₀, preferably C₇-C₁₂ alkylaryl group, a C₈-C₄₀, preferably C₈-C₁₂ arylalkenyl group or a halogen atom, preferably chlorine.

R³ and R⁴ are identical or different and are each a monocyclic or polycyclic hydrocarbon radical which can form a sandwich structure with a central atom M¹. R³ and R⁴ are preferably cyclopentadienyl, indenyl, tetrahydroindenyl, benzoindenyl or fluorenyl, it being possible for the parent structures to carry additional substituents or to be bridged with one another. Additionally one of the radicals R³ and R⁴ can be a substituted nitrogen atom, with R²⁴ having the definition of R¹⁷ and being preferably methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a radical —NR¹⁶₂, —SR¹⁶, —OSiR¹⁶₃, —SiR¹⁶₃ or —PR¹⁶₂ radical, in which R¹⁶ is a C₁-C₁₀, preferably C₁-C₃ alkyl group or C₆-C₁₀, preferably C₆-C₈ aryl group or else, in the case of radicals containing Si or P, is a halogen atom, preferably chlorine, or pairs of adjacent radicals R⁵, R⁶, R⁷, R⁸, R⁹ or R¹⁰ form a ring together with the carbon atoms connecting them. Particularly preferred ligands are the substituted compounds of the parent structures cyclopentadienyl, indenyl, tetrahydroindenyl, benzoindenyl or fluorenyl.

R¹³ is 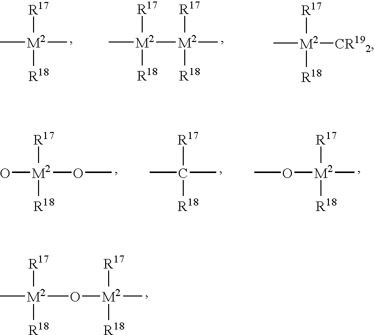
═BR¹⁷, ═AlR¹⁷, —Ge—, —Sn—, —O—, —S—, ═SO, ═SO_{2,} ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀, preferably C₁-C₄ alkyl, especially methyl, group, a C₁-C₁₀ fluoroalkyl, preferably CF₃ group, a C₆-C₁₀ fluoroaryl, preferably pentafluorophenyl, group, a C₆-C₁₀, preferably C₆-C₈ aryl group, a C₁-C₁₀, preferably C₁-C₄ alkoxy, especially methoxy, group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group, or a C₇-C₄₀, preferably C₇-C₁₂ alkylaryl group, or R¹⁷ and R¹⁸ or R¹⁷ and R¹⁹ in each case form a ring together with the atoms connecting them.

M² is silicon, germanium or tin, preferably silicon and germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.

R¹¹ and R¹² are identical or different and are as defined for R¹⁷. m and n are identical or different and are zero, 1 or 2, preferably zero or 1, where m plus n is zero, 1 or 2, preferably zero or 1.

R¹⁴ and R¹⁵ have the definition of R¹⁷ and R¹⁸.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconium dimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
and also the alkyl or aryl derivatives of each of these metallocene dichlorides.

The single-center catalyst systems are activated using suitable cocatalysts. Suitable cocatalysts for metallocenes of the formula I are organoaluminum compounds, especially aluminoxanes, or else aluminum-free systems such as R²⁰ₓNH₄₋ₓBR²¹₄, R²⁰ₓPH₄₋ₓBR²¹₄,
R²⁰₃CBR²¹₄ or BR²¹₃. In these formulae x is a number from 1 to 4, the radicals R²⁰ are identical or different, preferably identical, and are each C₁-C₁₀ alkyl or C₆-C₁₈ aryl, or two radicals R²⁰ form a ring together with the atom connecting them, and the radicals R²¹ are identical or different, preferably identical, and are each C₆-C₁₈ aryl which may be substituted by alkyl, haloalkyl or fluorine. In particular R²⁰ is ethyl, propyl, butyl or phenyl and R²¹ is phenyl, pentafluorophenyl, 3,5-bistrifluoromethylphenyl, mesityl, xylyl or tolyl.

Additionally a third component is often needed in order to maintain protection against polar catalyst poisons. Suitable for this purpose are organoaluminum compounds such as triethylaluminum, tributylaluminum and others, for example, and also mixtures.

Depending on the process it is also possible for supported single-center catalysts to be used. Preferred catalyst systems are those in which the residual levels of support material and cocatalyst do not exceed a concentration of 100 ppm in the product.

The silane for the modification reaction contains at least one olefinic double bond: for example, a vinyl group attached directly to the silicon atom, and also contains at least one alkoxy group linked directly to the silicon atom: a methoxy or ethoxy group, for example. Suitable silanes are alkoxyvinylsilanes of the general formula
CH₂═CR¹—(COO)ₓ(CₙH₂ₙ)_{y}Si(R²)_{z}(OR³)_{3-z},
where R¹ is hydrogen or CH₃ and R² and R³ are branched or unbranched alkyl radicals having 1-6 carbon atoms, n is 1-6t, x and y are 0 or 1, y being 1 if x is 1, and z is 0-2. Examples that may be mentioned of suitable silanes include trimethoxyvinylsilane, triethoxyvinylsilane, methyldimethoxyvinylsilane or methyldiethoxyvinylsilane or 3-methacryloyloxypropyltrimethoxysilane. Preference is given to trimethoxyvinylsilane or triethoxyvinylsilane, particular preference to trimethoxyvinylsilane.

The silane is used in an amount, based on polyolefin wax employed, of from 0.1 to 40%, preferably from 0.5 to 30%, more preferably from 1 to 10%, by weight.

The modification is carried out in the presence of free-radical initiators. Compounds suitable for this purpose are those which break down to a sufficient extent into free radicals under the modification conditions. Particularly suitable are organic peroxides, examples being alkyl, aryl or aralkyl peroxides such as di-tert-butyl peroxide or dicumyl peroxide, peroxy esters such as tert-butyl peracetate or tert-butyl perbenzoate, or hydroperoxides such as tert-butyl hydroperoxide or cumene hydroperoxide. Further possible free-radical initiators are aliphatic azo compounds such as azobis(2-methylpropionitrile) or 2,2′-azobis(2,4-dimethylvaleronitrile). Preference is given to dialkyl peroxides, and di-tert-butyl peroxide is particularly preferred. The free-radical initiator is employed in concentrations, based on polyolefin wax used, of from 0.1 to 10% by weight.

For reacting the polyolefin wax with the silane the wax is heated to a temperature above its melting point. Both the silane and the peroxide are introduced into the melt, separately or together, with inert gas blanketing where appropriate. The metered addition can take place continuously over a defined period or in one or more portions. The reaction temperature is situated above the melting point of the polyolefin wax, preferably between 100 and 200° C., more preferably between 130 and 180° C. The end of metered addition may be followed—optionally after an additional amount of free-radical initiator has been added—by an afterreaction at the same or a different temperature. Volatile fractions formed during the reaction, and/or unreacted silane, can be separated off by distillation and/or by stripping with inert gas.

The reaction can be conducted either batchwise or continuously and under either atmospheric or superatmospheric pressure.

The silane-modified waxes of the invention have a melt viscosity as measured at 170° C. of between 10 and 50 000 mPa.s, preferably between 50 and 10 000 mPa.s, a dropping point or ring & ball softening point of between 75 and 170° C., preferably between 85 and 150° C., and a heat of fusion of >10 J/g, preferably >20 J/g, more preferably >30 J/g and in particular >40 J/g, with particular preference 50 J/g.

The modified polyolefin waxes of the invention are largely stable to hydrolysis and crosslinking at room temperature but can be induced to crosslink rapidly by adding suitable catalysts and exposing the waxes to water or moisture. Examples of suitable catalysts include organotin compounds such as dibutyltin dilaurate, dibutyltin diacetate and dibutyltin dioctoate, and also inorganic tin compounds such as tin dichloride or tetrachloride, cobalt salts or lead salts, organic amines such as di- or trialkylamines, and organic or inorganic protic acids such as p-toluenesulfonic acid, sulfuric acid or hydrochloric acid.

### EXAMPLES 1 to 4

The dropping points were determined in accordance with DIN 51801, the melt viscosities in a rotational viscometer in accordance with DIN 53019, and the heats of fusion by differential thermoanalysis to DIN 51007.

The dropping point characterizes the melt behavior of solid fats, lubricants, bitumens, etc. The dropping point is the temperature point at which the test material, applied to the mercury bulb of a thermometer—or to nipples, fastened thereto, of dropping point measuring instruments (of the Ubbelohde type, for example)—drops off under its own weight.

According to DIN 51801/2 the determination of dropping point with an Ubbelohde-type dropping point apparatus is performed as follows: Cemented to the lower part of a thermometer is a cylindrical metal sleeve onto which a second metal sleeve can be screwed. At the side of this second metal sleeve there is a small opening for pressure compensation and, in the lower part, three locking pins at a distance of 7.5 mm from the lower edge of the sleeve. A cylindrical nipple with a downward taper, made from a copper-zinc alloy (brass) with a copper content of between 58% and 63% by weight, fits into the sleeve.

The upper part of the metal sleeve must be cemented to the thermometer such that when the lower part is screwed on tightly the lower edge of the thermometer vessel ends at the same point as the lower edge of the metal sleeve. The locking pins in the metal sleeve allow the nipple to be introduced into the sleeve in such a way that at any given point the thermometer vessel is equidistant from the walls of the nipple.

The prepared sample in a pourable state is introduced to excess into the nipple, which stands on the plate.

At a temperature at which push-on application is still just possible the nipple is pushed carefully onto the mount on the thermometer so that the thermometer vessel is not in contact with the nipple wall.

The thermometer with the nipple is fixed in the middle of the test tube by means of a stopper which has a central through-bore and a notch at one side. The distance between the bottom edge of the nipple and the base of the test tube should be 25 mm. The test tube is suspended vertically in the beaker at up to two thirds of its length. The beaker contains ice-water as the bath liquid. The dropping point instrument is then heated so that, starting from about 10° C. below the anticipated dropping point, the temperature increases uniformly by 1° C. per minute.

As the temperature rises, the sample gradually softens. An observation is made of the temperature at which the binder running out from the nipple has reached the base of the test tube.

The melt viscosity in accordance with DIN 53019 is determined as follows: The liquid under investigation is located in an annular gap between two coaxial cylinders of which one (the rotor) rotates at a constant speed while the other (the stator) is stationary. A determination is made of the rotary speed and of the torque required to overcome the frictional resistance of the liquid within the annular gap. From the geometric dimensions of the system and from the torque and speed values determined it is possible to calculate the shear stress prevailing in the liquid, and the shear rate.

By specifying defined geometrical proportions, the aforementioned standard describes a standard flow pattern for measuring the rheology of newtonian and non-newtonian liquids in rotational viscometers with coaxial cylinders.

The determination of the heats of fusion by differential thermoanalysis to
DIN 51007 is performed as follows:

The sample under analysis and the reference sample are subjected to heating or to another temperature program and the different heat flows (as temperature differences) are measured over defined periods of time. They can be reproduced in a diagram which is characteristic of each sample.

### Implementation of the Examples

500 g of each of the polyolefin waxes listed in Table 1, prepared using metallocene catalysts, were melted in a glass apparatus equipped with stirrer mechanism, internal thermometer and distillation bridge and under nitrogen blanketing. At a temperature of 160° C. the quantity of silane indicated in Table 2 was metered in continuously over the course of 3 h from a metering funnel, while at the same time 10 g of di-tert-butyl peroxide were added continuously from a second dropping funnel. After the end of the metered addition a further 1.1 g of di-tert-butyl peroxide were added to the reaction mixture and the reaction was allowed to continue for 1 h at 160° C. Then a vacuum (approximately 30 mbar) was applied and the volatile fractions were distilled off. After about 30 minutes the system was let down to atmospheric pressure by introduction of nitrogen. The properties of the resulting modification products are specified in Table 2.

TABLE 1

| | | | Dropping | Heat of |
|---|---|---|---|---|
| | | Visc./170° C. | point | fusion |
| | Wax type | mPa · s | ° C. | J/g |
| A | Ethylene homopolymer | 40 | 127 | 260 |
| | wax | | | |
| B | Ethylene-propylene | 110 | 115 | 145 |
| | copolymer wax | | | |
| C | Propylene homopolymer | 550 | 145 | 78 |
| | wax | | | |
| D | Propylene-ethylene | 60 | 120 | 60 |
| | copolymer wax | | | |

TABLE 2

| | | | Silane used | | | Heat |
|---|---|---|---|---|---|---|
| Ex- | | Silane | relative | Dropping | Viscosity/ | of |
| am- | Wax | com- | to wax | point | 170° C. | fusion |
| ple | used | ponent | % by weight | ° C. | mPa · s | J/g |
| 1 | A | TMVS*) | 10 | 116 | 70 | 210 |
| 2 | B | TMVS*) | 5 | 104 | 180 | 110 |
| 3 | C | TMVS*) | 10 | 136 | 320 | 65 |
| 4 | D | TEVS**) | 10 | 111 | 60 | 40 |

*)Trimethoxyvinylsilane
**)Triethoxyvinylsilane

To test for storage stability a sample of the wax described in Example 3 was cast to form a plate having a diameter of 7 cm and a thickness of 0.5 cm. The plate was stored under standard atmospheric conditions (23° C., 50% humidity) for 8 days. The melt viscosity of the stored sample was 350 mPa.s at 170° C.

To test the crosslinking capacity, 50 g of the wax were blended in the melt with 0.05 g (0.1%) of dibutyltin dilaurate. A plate was cast as above. After 8 days' storage under standard atmospheric conditions the sample had crosslinked fully and was no longer meltable.

1. A partially crystalline polyolefin homopolymer or copolymer wax comprising at least one polyolefin wax modified free-radically with a silane compound and having a melt viscosity as measured at 170° of between 10 and 50 000 mPa.s and a heat of fusion >10 j/g, wherein the silane compound used for modification includes at least one olefinic double bond and at least one alkoxy radical attached directly to silicon and wherein the at least one polyolefin wax used for modification is a metallocene catalyzed polyolefin wax.

2. A partially crystalline polyolefin homopolymer or copolymer wax as claimed in claim 1, having a melt viscosity as measured at 170° C. of between 50 and 10 000 mPa.s, a dropping point or ring & ball softening point of between 75 and 170° C., and a heat of fusion of >20 J/g.

3. A partially crystalline polyolefin homopolymer or copolymer wax as claimed in claim 1 having a heat of fusion of >40 J/g.

4. A partially crystalline polyolefin homopolymer or copolymer wax as claimed in claim 1 wherein the at least one polyolefin wax is a 1-olefin having 2 to 18 carbon atoms.

5. A partially crystalline polyolefin homopolymer or copolymer wax as claimed in claim 1, wherein the at least one polyolefin wax is at least two 1-olefins each having 2 to 18 carbon atoms.

6. A partially crystalline polyolefin homopolymer or copolymer wax as claimed in claim 1, wherein the at least one polyolefin wax further comprises from 80 to 100 mol % of propylene and from 0 to 20 mol % of ethylene or from 80 to 100 mol % of propylene and from 0 to 20 mol % of a C₄-C₁₀ 1-olefin.

7. A partially crystalline polyolefin homopolymer or copolymer wax as claimed in claim 1 wherein the silane compound further comprises at least one alkoxyvinylsilane of the general formula
CH₂═CR¹—(COO)ₓ(CₙH₂ₙ)_{y}Si(R²)_{z}(OR³)_{3-z},
in which R¹ is hydrogen or CH₃ and R² and R³ are branched or unbranched alkyl radicals having 1 to 6 carbon atoms, n is 1 to 6, x and y are 0 or 1, y being 1 if x is 1, and z is 0 to 2t.

8. A partially crystalline polyolefin homopolymer or copolymer wax as claimed in claim 1, wherein the silane compound further comprises vinyltrimethoxysilane or vinyltriethoxysilane.

9. A partially crystalline polyolefin homopolymer or copolymer wax as claimed in claim 1, having a dropping point of between 75 and 170° C.

10. A process for preparing a partially crystalline polyolefin wax modified free-radically with at least one silane compound and having a viscosity as measured at 170° C. of between 10 and 50 000 mPa.s and a heat of fusion of >10 J/g comprising the step of reacting a polyolefin wax with at least one unsaturated silane compound in the presence of a free-radical initiator, wherein the polyolefin wax is a metallocene catalyzed polyolefin wax.

11. The process as claimed in claim 10, wherein the at least one unsaturated silane compound is vinyltrimethoxysilane or vinyltriethoxysilane.

12. A hot-melt adhesive comprising a partially crystalline polyolefin homopolymer or copolymer wax as claimed in claim 1.

13. A polymer compound comprising a partially crystalline polyolefin homopolymer or copolymer wax as claimed in claim 1 and at least one of glass fibers, natural fibers or wood flour.

14. An adhesive for bonding paper, cardboard, wood, glass, metal, polyamides, polyesters or polyolefins, including polyolefins containing partly fluorinated or perfluorinated olefins comprising a partially crystalline polyolefin homopolymer or copolymer wax as claimed in claim 1.

15. A partially crystalline polyolefin homopolymer or copolymer wax as claimed in claim 1, having a dropping point or ring & ball softening point between 85 and 150° C.

16. A partially crystalline polyolefin homopolymer or copolymer wax as claimed in claim 1, having a heat of fusion of >30 J/g.

17. A partially crystalline polyolefin homopolymer or copolymer wax as claimed in claim 1, having a heat of fusion of >50 J/g.

18. A partially crystalline polyolefin wax made in accordance with the process of claim 10.

19. A hot-melt adhesive comprising a partially crystalline polyolefin wax as claimed in claim 18.

20. A polymer compound comprising a partially crystalline polyolefin wax as claimed in claim 18 and at least one of glass fibers, natural fibers or wood flour.

21. An adhesive for bonding paper, cardboard, wood, glass, metal, polyamides, polyesters or polyolefins, including polyolefins containing partly fluorinated or perfluorinated olefins comprising a partially crystalline polyolefin wax as claimed in claim 18.
